(19) United States
(12) Patent Application Publication
(10) Pub. No.: US 2004/0234198 A1
(43) Pub. Date: Nov. 25, 2004

(54) Tunable and switchable multiple-cavity thin film optical filters

(75) Inventors: Matthias Wagner, Cambridge, MA (US); Lawrence H. Domash, Conway, NH (US)

Correspondence Address: WILMER CUTLER PICKERING HALE AND DORR LLP, 60 STATE STREET, BOSTON, MA, 02109, US

(73) Assignee: Aegis Semiconductor, Inc., Woburn, MA

(21) Appl. No.: 10/804,640

(22) Filed: Mar. 19, 2004

Related U.S. Application Data
(60) Provisional application No. 60/456,788, filed on Mar. 21, 2003.
(60) Provisional application No. 60/482,733, filed on Jun. 26, 2003.
(60) Provisional application No. 60/513,399, filed on Oct. 22, 2003.

(51) Int. Cl. G02B 6/26

(52) U.S. Cl. 385/27

(57) ABSTRACT

A switchable optical filter including a first thin-film optical bandpass filter portion; and a second thin-film optical bandpass filter portion, wherein both the first and second thin-film optical bandpass filter portions are adjacent to each other and form parts of single integral structure, and wherein the first thin-film optical bandpass filter is thermally tunable and is characterized by a passband that shifts as a function of temperature and wherein the second thin-film optical bandpass filter is thermally non-tunable.

### CROSS-REFERENCE TO RELATED APPLICATIONS

This application claims the benefit of U.S. Provisional Application No. 60/456,788, filed Mar. 21, 2003; U.S. Provisional Application No. 60/482,733, filed Jun. 26, 2003; and U.S. Provisional Application No. 60/513,399, filed Oct. 3, 2003.

### TECHNICAL FIELD

This invention relates to switchable optical filters.

### BACKGROUND

Requirements for dynamic fiber optic components, including not only tunable filters but also diverse wavelength management and control devices such as switchable add/drop filters and tunable dispersion compensators, are increasingly important in emerging wavelength division multiplexing (“WDM”) network architectures. Functionality requirements vary widely by application. For example, filters for monitoring purposes are typically continuously tunable, narrow Fabry-Perots working on a tapped signal so that insertion loss is not critical. On the other hand, tunable add/drop filters in the signal path must provide very low insertion loss, square band pass shapes, large reflection isolation, and controlled chromatic dispersion. In some architectures it is also desirable that they be ‘hitless,’ that is, displaying no transmission between target channels. Some of the needs for add/drop filters are ‘set and forget’ applications aimed at reducing filter parts inventories, while others demand rapid tunability for dynamically reconfigurable networks.

A wide variety of tunable or switchable technologies have been developed to try to meet the needs of wavelength division multiplexing, most prominently based on MEMS, but also including stretched fiber Bragg gratings, thermo-optic waveguides, liquid crystal devices, and others. Within these diverse approaches it is notable that thin film interference filters, the most widely deployed type of static, fixed WDM filter, have led to relatively few dynamically tunable or switchable counterparts. Thin film narrowband filters can be tuned by mechanical rotation of the angle of incidence, and linear variable filters are commercially available based on spatially graded deposition, tunable by linear translation.

### SUMMARY

In general, in one aspect, the invention features a switchable optical filter including:a first thin-film optical bandpass filter portion; and a second thin-film optical bandpass filter portion, wherein both the first and second thin-film optical bandpass filter portions are adjacent to each other and are parts of a single integral structure, and wherein the first thin-film optical bandpass filter portion is thermally tunable and is characterized by a passband that shifts as a function of temperature and wherein the second thin-film optical bandpass filter portion is thermally non-tunable.

Other embodiments include one or more of the following features. The first and second thin-film optical bandpass filter portions are integrally formed one on top of the other. The second thin-film optical bandpass filter portion includes a Fabry-Perot cavity or alternatively includes a plurality of cavities fabricated one on top of the other. The second thin-film optical bandpass filter portion includes an etalon that is characterized by multiple passbands spaced from each other and wherein the passband of first thin-film optical bandpass filter portion is thermally tunable over the multiple passbands of the etalon. The first thin-film optical bandpass filter portion includes a Fabry-Perot cavity. Or the first thin-film optical filter portion includes a plurality of cavities fabricated one on top of the other. The first thin-film optical bandpass filter portion includes a heating element for controlling a temperature of the first thin-film optical bandpass filter. The first thin-film optical bandpass filter portion includes a layer or multiple layers of amorphous silicon.

In general, in another aspect, the invention features a switchable optical filter including: a first thermally tunable thin-film optical bandpass filter portion; a second thermally tunable thin-film optical bandpass filter portion, wherein both the first and second tunable thin-film optical bandpass filters are arranged next to each other on an optical path; and a spacer separating and thermally isolating the first and second tunable thin-film optical bandpass filter portions from each other so that either one of said first and second optical bandpass filter portions can be thermally tuned independently of the other one of them.

Other embodiments include one or more of the following features. The spacer is an air gap or a solid dielectric material such as silica. The first thermally tunable thin-film optical bandpass filter portion is characterized by a first passband that shifts as a function of temperature, and includes a first heater element for controlling a temperature of the first thermally tunable thin-film bandpass filter portion so as to control a location of the first passband. The second thermally tunable thin-film optical bandpass filter portion is characterized by a second passband that shifts as a function of temperature and includes a second heater element for controlling a temperature of the second thermally tunable thin-film bandpass filter portion so as to control a location of the second passband.

In general, in still yet another aspect, the invention features a switchable optical filter that includes: a first optical bandpass filter portion; and a second optical bandpass filter portion, wherein both the first and second optical bandpass filter portions are arranged adjacent to each other to form a single interferometrically-coupled optical filter structure, and wherein the first optical bandpass filter portion is tunable and is characterized by a passband that shifts as a function of a control parameter and wherein the second optical bandpass filter portion is non-tunable.

In other embodiments the control parameter is temperature.

In general, in still yet another aspect, the invention features a switchable optical filter including: a first tunable optical bandpass filter portioin characterized by a first passband that shifts as a function of a first control parameter; and a second tunable optical bandpass filter portion characterized by a second passband that shifts as a function of a second control parameter, wherein both the first and second optical bandpass filter portions form a single integral interferometrically-coupled structure.

Other embodiments include one or more of the following features. The first control parameter is a temperature of the first tunable optical bandpass filter portion and the second control parameter is a temperature of the second tunable optical bandpass filter portion. The switchable optical filter also includes a spacer separating and isolating the first and second tunable optical bandpass filter portions from each other so that either one of said first and second optical bandpass filter portions can be tuned independently of the other one of them. The first tunable optical bandpass filter portion includes a heater element for controlling the temperature of the first tunable optical bandpass filter and the second tunable optical bandpass filter portion includes a heater element for controlling the temperature of the second tunable optical bandpass filter.

In general, in another aspect, the invention features an add/drop optical circuit including a plurality of switchable thin-film optical filters each of which has a first optical terminal for receiving an optical signal, a second optical terminal for outputting an optical signal that is reflected by that switchable thin-film optical filter and a third optical terminal for carrying an optical add/drop signal, wherein the switchable thin-film optical filters of the plurality of switchable thin-film optical filters are connected in series via the first and second optical terminals of the plurality of switchable thin-film optical filters and wherein each of the switchable thin-film optical filters of the plurality of switchable thin-film optical filters comprises a thermally tunable thin-film optical bandpass filter portion having a passband that shifts as a function of temperature.

Other embodiments include one or more of the following features. Each switchable thin-film optical filter of the plurality of switchable thin-film optical filters further includes a second thin-film optical bandpass filter portion, wherein both the first and second thin-film optical bandpass filters form a single integral filter structure, and wherein the second thin-film optical bandpass filter portion is thermally non-tunable. Each switchable thin-film optical filter of the plurality of switchable thin-film optical filters further includes: a second thermally tunable thin-film optical bandpass filter portion; and a spacer separating and thermally isolating the first-mentioned and second tunable thin-film optical bandpass filter portions from each other so that either one of the first and second optical bandpass filter portions can be thermally tuned independently of the other one of them, wherein the first-mentioined and second tunable thin-film optical bandpass filter portions and the spacer form a single integral filter structure.

Based on wafer scale manufacturing and testing, thermo-optic thin films may offer active tunable devices for a variety of network applications at a cost comparable to conventional passive devices.

Also, due to their compactness, the thin-film optical switches described herein can be conveniently packaged within a very small footprint, such as a TO can, as described in U.S. Ser. No. 10/306,056, entitled “Package for Optical Components,” filed Nov. 27, 2002 and incorporated herein by reference.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A shows the transmission characteristics of a thermo-optically tunable filter.

FIG. 1B shows the change of the location of the passband vs. temperature for a single cavity filter.

FIG. 2 shows the transmission characteristics of a thermo-optically tunable dual-cavity filter.

FIG. 3 shows an optical switch that employs a thermo-optically tunable, thin-film interference filter.

FIGS. 4A, 4B and 4C are examples of the transmission and reflection spectra of a five cavity optical switch at 49° C., 69° C., and 164° C., respectively.

FIG. 4D shows the transmission and reflection characteristics of a five-cavity optical switch at a fixed wavelength of 1548 nm as a function of temperature.

FIG. 5 shows an optical switch that employs a thermo-optically tunable, thin-film interference filter along with an etalon Fabry-Perot cavity.

FIG. 6 shows the transmittance of an etalon as a function of wavelength.

FIG. 7 shows an optical switch employing two thermo-optically tunable thin-film filters.

FIG. 8 shows the transmission characteristics of an optical switch similar to the one shown in FIG. 7.

FIG. 9 is an add/drop module incorporating optical switches of the type described herein.

FIG. 10 shows the optical switch that is used in the add/drop module of FIG. 9.

### DETAILED DESCRIPTION

The optical filters that are to be described herein are based on the thermo-optically tunable thin-film filter technology that is described in U.S. Ser. No. 10/174,503, filed Jun. 17, 2002 and in U.S. Ser. No. 10/211,970, filed Aug. 2, 2002, both of which are incorporated herein by reference. In general, the thermo-optically tunable filter described in those references employs a multi-layer interference film in which at least some of the layers are made of a material (e.g. amorphous silicon) that has an unusually high thermo-optic coefficient as compared to what is typically used to make optical interference filters. The resulting structure produces a bandpass filter in which the spectral location of the bandpass region (i.e., the passband) varies as a function of temperature. Thus, the optical characteristics of the bandpass filter can be tuned over a meaningful range of wavelengths by changing the temperature of the device.

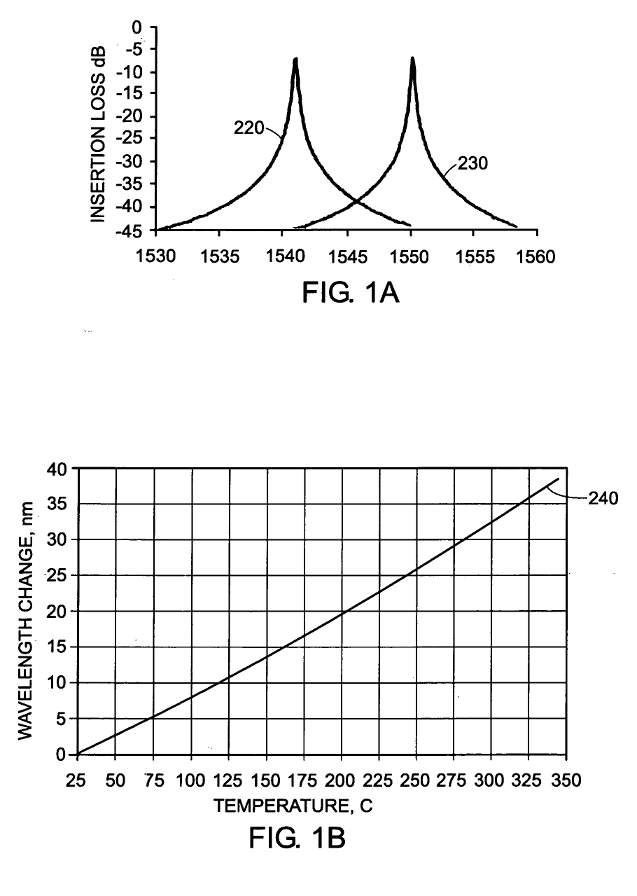

As indicated in the above-mentioned references, a Fabry-Perot filter that incorporates a high thermo-optic coefficient material yields superior characteristics to those that are obtainable from a single multi-layer interference coating that incorporates the high thermo-optic coefficient materials. For example, a single cavity Fabry-Perot filter produces more sharply peaked passbands that have broader skirts. The thermo-optical tunability of such a structure is illustrated in FIG. 1A, which shows the transmission characteristics for a single cavity thermo-optic filter fabricated on a fused silica substrate. At 25° C., its passband 220 is located at about 1540.95 nm and at 125° C. its passband 230 has shifted to about 1550.15 nm. As the temperature is increased from 25° C. to 125° C., the passband gradually shifts from 1540.95 nm to 1550.15 nm. FIG. 1B shows a plot of how much the passband moves as a function of temperature from 25° C. to about 350° C.

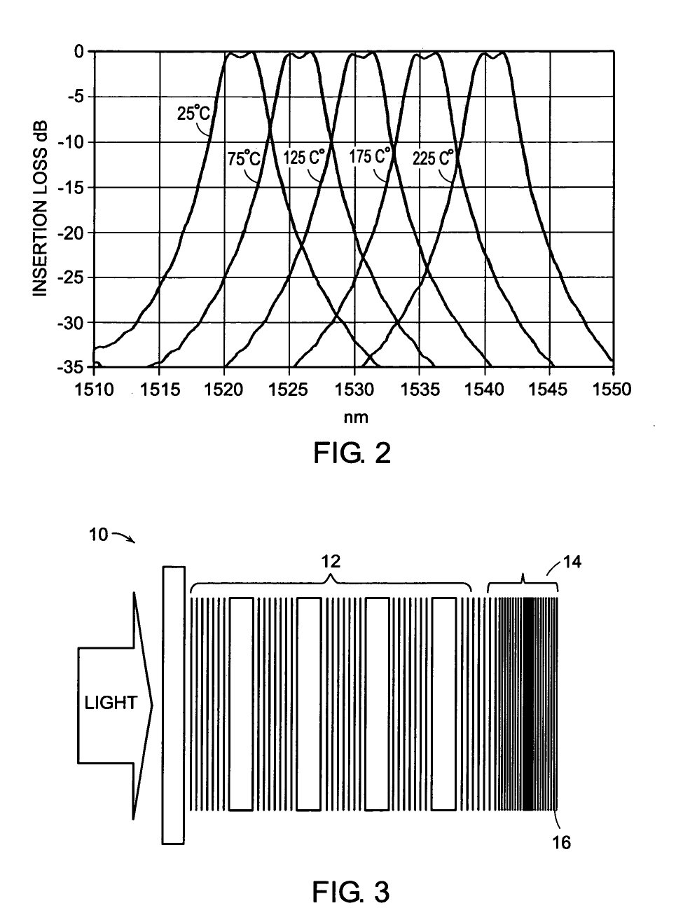

Multi-cavity filters in which each cavity incorporates the high thermo-optic coefficient material produce similar tunability but with better-shaped, broader passbands having flatter tops, i.e., passbands that are particularly well suited for add/drop filters. This is illustrated in FIG. 2, which shows the transmission curves from a dual cavity filter at temperatures 25-225° C. The thermal tuning coefficient over the range 25-225° C. is about 95 pm/° C., which is similar to the single cavity case. As indicated, the dual cavity filter maintains its bandshape over this temperature range. The principles of multi-cavity, thin-film filters are discussed in the publicly available literature such as, for example, “Thin-Film Optical Filters” by A. Macloud, 3^{rd} Edition, published by Institute of Physics Publishing, Bristol, England; and “Optical Interference Coatings Technical Digest,” July 2001, published by the Optical Society of America, Washington, D.C. 2001.

The embodiments described herein are hybrid integral structures that incorporate one or more of these thermo-optically tunable thin-film filter portions. Two general categories of hybrids are presented. In one category, a thermo-optically tunable thin-film filter portion is combined with an optical thin film filter portion that is not tunable (i.e., a static optical filter) to produce a single multi-cavity thin-film filter structure. In the other category, a thermo-optically tunable thin-film filter portion is combined with another thermo-optically tunable thin-film filter portion, to produce another type of multi-cavity structure. The resulting combinations produce extremely compact thin-film filter structures that switch thermo-optically between transmissive and reflective states at particular wavelengths. For the optical filters of the first category, the wavelengths at which the switching is possible are fixed at values determined by the design of the filter. For the optical filters of the second category, the wavelengths at which switching is possible are selectable by the user within an operating range. Examples of structures in each of these two categories will now be described.

First Hybrid Structure

Referring to FIG. 3, an optical switch 10 that illustrates an embodiment from the first category is an integral structure including two thin-film, optical interference filter portions 12 and 14, one fabricated on top of the other one to produce a single multi-cavity structure. In this particular embodiment, optical filter portion 14 is a thermo-optically tunable single cavity Fabry-Perot filter that incorporates thermo-optic semiconductor films within its structure; and optical filter portion 12 is a static, multi-cavity (i.e., four cavity) filter in which the constituent thin-film layers making up the structure have a low thermo-optic coefficient. Optical filter portion 14 is characterized by a transmission curve that has a bandpass region the location of which varies as a function of the temperature of the filter; whereas, optical filter portion 12 has a bandpass region that remains substantially fixed as a function of temperature, i.e., it is not thermo-optically tunable. In view of the close coupling of these two thin-film filter portions, the resulting integral structure will function as a single interferometrically coupled system having a passband characterized by a flat top that is preserved throughout its operation.

As is generally understood by those skilled in the art, a “cavity” is a structure that is formed by a pair of thin-film interference mirrors separated by a spacer. A single cavity filter is a simple Fabry-Perot filter. A multiple cavity filter is an advanced high performance narrow band thin film filter in which the constituent cavities are not just arbitrary in their structure but tend to keep to a repeated format and are coupled by coupling layers to combine their effects interferometrically to achieve the desired band pass shapes.

Optical filter portion 14 includes within its structure a heating element 16 that enables one to change the temperature of the filter and thereby control the location of its passband. In the described embodiment, heating element 16 is a layer of the multi-film interference mirror that is made of an electrically resistive material such as doped crystalline silicon. There are, of course, other ways to heat the relevant portions of the film filter. For example, one could use a layer of n-type polysilicon or ZnO or doped crystalline silicon on which the filter stack is fabricated or one could use the membrane structures that are disclosed in U.S. Provisional Patent Applications Numbered 60/509,379, 60/509200, and 60/509,203 all of which were filed in Oct. 7, 2003 and all of which are incorporated herein by reference.

Note the transmission characteristics of switch 10 are determined by the relative positions of the passbands of optical filter portions 12 and 14. In this example, it is assumed that the passband of static optical filter portion is λ₁ and the passband of the tunable optical filter portion can vary continuously from λ₀ to λ₂, where λ₀<λ₁<λ₂ When the passband of tunable optical filter portion 14 is not aligned with the passband of optical filter portion 12, switch 10 blocks the transmission of a signal at wavelength λ₁. When the passband of tunable optical filter portion 14 is brought into alignment with the passband of optical filter portion 12 by heating optical filter 14 so that its passband moves to λ₁, switch 10 allows the signal at wavelength λ₁ to pass through the switch. In other words, the transmission characteristics of switch 10 can be switched from transmissive to reflective states by adjusting the temperature of tunable optical filter portion 14. This property can be used to switch a channel from a drop port to a through port in an add/drop module by heating the filter.

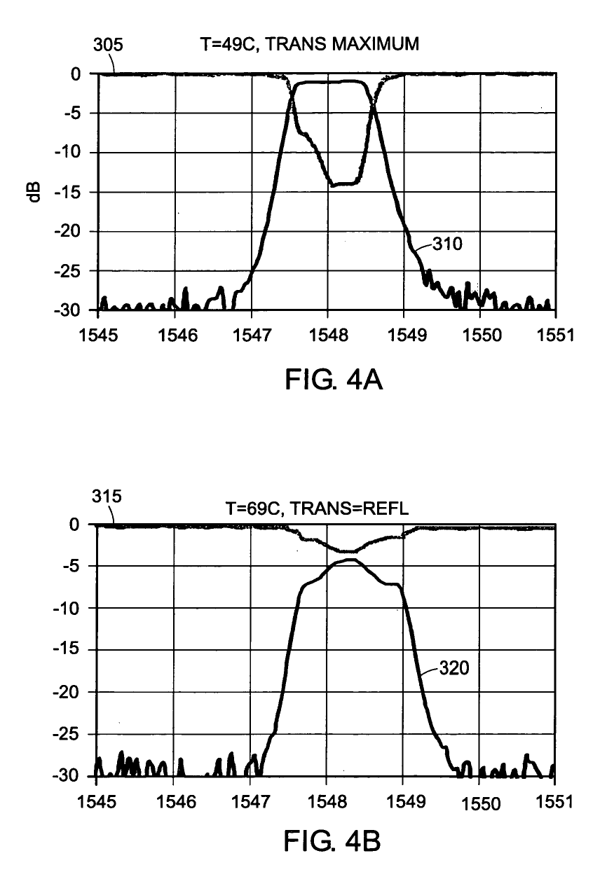

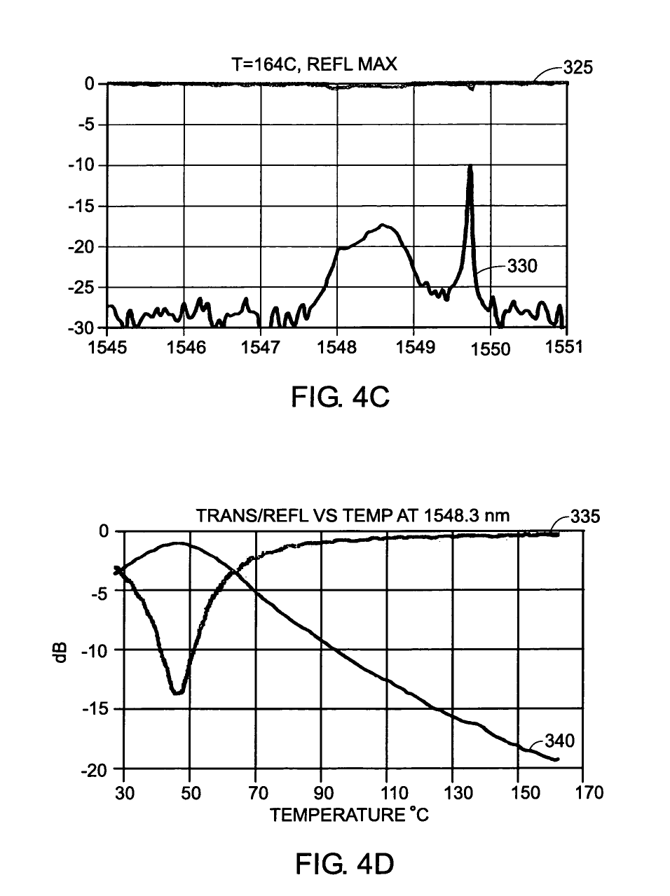

FIGS. 4A through 4D show measurements that were made on an optical switch that included five cavities, four of which were matched cavities made from conventional dielectric materials and the fifth was a thermo-optically tunable cavity formed by alternating layers of amorphous silicon (a-Si:H) and silicon nitride (SiNₓ). It should be understood that this specific example is meant to demonstrate the ideas and is only one simple design among many other designs that are possible.

The four matched cavities of the static filter were deposited on a white crown glass substrate by a conventional WDM-qualified filter process, such as e-beam evaporation or ion assisted sputtering, using a conventional dielectric thin film high/low index pair such as tantalum pentoxide (Ta₂O₅) and silicon dioxide (SiO₂). Both of those materials exhibit very small thermo-optic coefficients and typically produces filters with<0.001 nm/° K thermal tunability. Standard optical monitoring techniques were used to match the four cavities. This portion of the filter had 104 layers and a center wavelength of 1548.3 nm at 25° C. and a thermo-optic tuning coefficient of about 1 pm/° C.

The fifth, thermally sensitive, cavity forming the tunable filter portion was fabricated by PECVD on top of the four cavities. This structure included an additional 13 layers consisting of a-Si:H/SiNₓ quarter wave mirror pairs and a-Si:H spacer. The fifth spacer thickness was deposited such that at room temperature its resonant wavelength was 1545.8 nm, just a few nm below that of the underlying four passive cavities, with the result that filter is almost totally reflective (non-transmissive) at the design channel wavelength at 25° C. As the temperature of the device is increased, a “resonant temperature” is reached where the fifth cavity becomes interferometrically matched to the group of four. In this state, the whole structure behaves as a narrow band transmission filter (see FIG. 4A). As the temperature is further increased above the match point, the five-cavity filter again becomes less transmissive and more reflective (see FIG. 4B).

At the “resonant temperature” 49° C. indicated by maximum transmission, the reflectivity curve 305 and transmissivity curve 310 of FIG. 4A show that the bandpass shape was comparable to a conventional 200 GHz WDM add/drop filter, with width of 0.9 nm at the −0.5 dB points, width of 2.5 nm at the −25 dB points, transmission insertion loss of −0.95 dB, and reflectivity −13.9 dB. In FIG. 4B, the reflectivity curve 315 and transmissivity curve 320 show that at a temperature of 69° C. the filter is approximately a 50-50 beamsplitter at the defined channel. In FIG. 4C, reflectivity curve 325 and transmissivity curve 330, at a temperature of 164° C., show that the transmission has been suppressed by −18.4 dB relative to the maximum transmission state at 49° C. and the reflectivity insertion loss becomes<−0.5 dB. (The spurious peak in the suppressed transmission spectrum is accounted for by a thickness error in the top quarter-waves of silicon.) In FIG. 4D, reflectivity curve 335 and transmissivity curve 340 demonstrate that the switch's transmissivity and reflectivity are a continuous function of temperature at 1548.3 nm.

In summary, this particular multi-cavity filter, which consists of five cavities, four of which are static and one of which is thermo-optically tunable, acts as a switchable add drop filter. The filter transmits nothing unless the five cavities are tuned to the same wavelength by thermally scanning the one tunable cavity. This structure yields variable transmission at a fixed wavelength.

Second Hybrid Structure

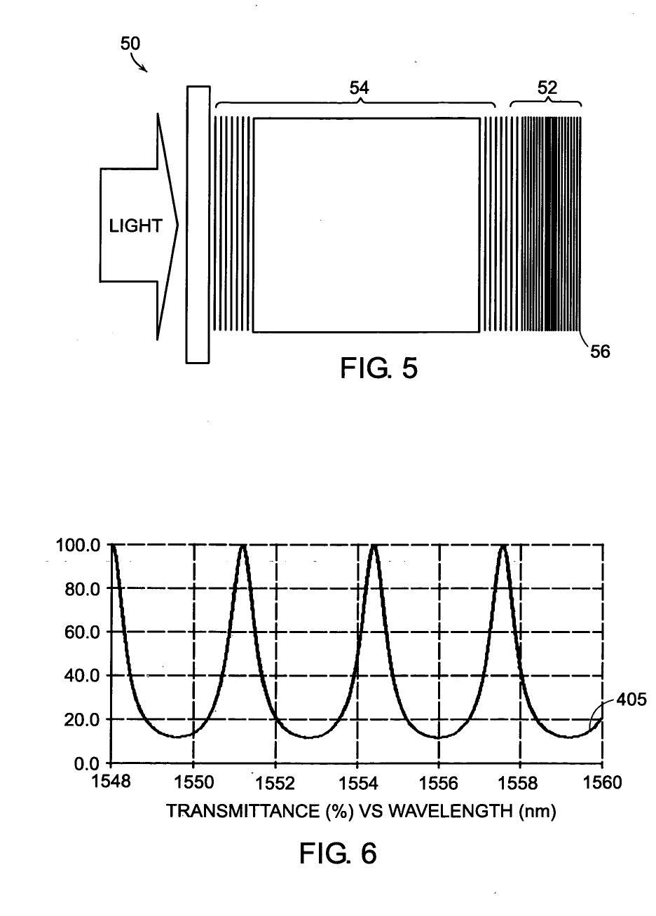

Referring to FIG. 5, an optical switch 50 that illustrates another embodiment from the first category is an integral structure including a thermo-optic cavity or multi-cavity filter portion 52 with a static, non thermo-optic etalon portion 54, which is much thicker than thermo-optic filter portion 52. Like the first embodiment, these two portions are part of a single thin-film multi-cavity structure and they form a single interferometrically-coupled system. As before, thermo-optic filter portion 52 includes a heating element or film 56 that is used to thermally control the position of the passband of the thermo-optically tunable filter. For reasons that will become apparent shortly, optical switch 50 functions as a switchable, periodic filter.

An etalon is basically a Fabry-Perot cavity, except that the spacer is much thicker than the thin film described earlier. Any Fabry-Perot cavity has multiple wavelengths or frequencies of resonant transmission which are spaced according to the free spectral range (FSR), which in terms of wavelength is given by: λ²/2nd, where n is the index of refraction and d the physical thickness of the spacer. (In frequency space, where it is even simpler to understand the FSR concept because the recurrences are evenly spaced, the formula is just c/2nd where c is speed of light and d is the physical thickness of the spacer.) In the case of a Fabry-Perot cavity that has a thin spacer, the FSR can be quite large. For a typical telecom thin film filter designed for 1550 nm, the thickness of an amorphous silicon spacer might be 418 nm (an even number of half wavelengths). With an index of 3.7, the FSR=775 nm. This is very large in view of the fact that the entire range of operation of a telecom system may only be the C band from 1528 to 1560 nm. The recurrences of transmission peaks of such a filter are completely without practical effect because they fall far outside the range of interest. If the spacer is made larger, however, the FSR becomes much smaller values. For example, assume that the spacer is a thicker slab of glass or fused silica or silicon or other substrate material instead of a thin film. Using the formula above, if the operating wavelength is at or near 1550 nm and a silica spacer is used (i.e., n=1.48), then a thickness d=1.014 mm will produce periodic transmission every 0.8 nm=FSR. This particular value would be convenient for telecom because in some networks, the channels are spaced by 0.8 nm (more exactly, by 100 GHz) and so such an etalon would transmit all channels on the so called ITU grid but not in between.

FIG. 6 shows a spectrally periodic transmission curve 405 for a single Fabry-Perot cavity including of a somewhat thinner, 0.253 mm fused silica etalon with partially transmitting thin film mirrors on each side. The precise structure of the filter that produced this curve is:

(BA)³ (Etalon cavity) (AB)³,

where B is a silicon dioxide thin film that is a quarter wave thick, A is a tantalum pentoxide thin film that is a quarter wave thick, and the notation (BA)^{α} refers to a pair of thin films B and A repeated α times (i.e., BABABA). This Fabry-Perot cavity was designed to have an FSR of 3.2 nm.

Combining the thermo-optically tunable thin film filter with the etalon produces a switch in which the transmission channel is selectable. The tunable optical filter operates as previously discussed in connection with the first embodiment. As the passband of tunable filter shifts in wavelength as the temperature changes, there will be multiple occasions at which the passband aligns with a corresponding one of transmission bands of the Fabry-Perot etalon. At those occasions, the optical switch will allow an optical signal through at the wavelength of the aligned passbands. At all other occasions (i.e., when the passband of the tunable optical filter is between the transmission peaks of Fabry-Perot etalon), the optical switch will block the transmission of the optical signal.

In the described embodiment, the thin film thermo-optic cavity (or multi-cavity) portion is added by depositing the appropriate thin films on top of the etalon cavity discussed above. The total formula for the resulting structure is:

(BA)³ E (AB)³ A L (HL)⁵ 4H (LH)⁵,

where E=Etalon cavity, H=amorphous silicon and L=silicon nitride. The “A L” quarter wave layers are present as “coupling layers” to connect the phases of the two cavities.

As the temperature is now changed over a range of 200° C., the tantalum pentoxide layer (A), the silicon dioxide layer (B), and the silicon nitride layer (L) will experience no substantial change, but the amorphous silicon layer (H), with a fractional index change of (1/n) dn/dT=6.8×10⁻⁵/° C. will cause substantial tuning of the thermo-optic cavity, scanning its center wavelength by about 21 nm from 1550 to 1571 nm. As it scans, there is no substantial transmission except at the wavelengths where the fixed etalon has resonance, i.e., every 3.2 nm. Thus, the overall transmission will be small except that it will periodically be large when this resonance condition is satisfied. Stated differently, transmission occurs only when the tunable thin film cavity is synchronous with the non-tunable but periodic thick etalon, with no transmission at wavelengths in between.

Of course, there is nothing unique about the parameters, materials, mirror pairs, etc. that were specified. The phenomenon will always be present when a substantially fixed thick etalon is joined to a tunable thin film filter with appropriate coupling layers. Many variations of spectral widths, periods, wavelengths of operation and other parameters are possible.

This particular device is good for selecting from among a group of optical signals the particular signal allowed to pass. An embodiment with an etalon with periodic transmission every 0.8 nm, is convenient for telecom applications where the channels are spaced by exactly 0.8 nm (more exactly, by 100 GHz) and such an etalon would transmit all channels on the so-called International Telecommunications Union (“ITU”) grid but not in between. The switch can be tuned to transmit at each of the grid wavelengths in sequence but not at the wavelengths in between.

Third Hybrid Structure

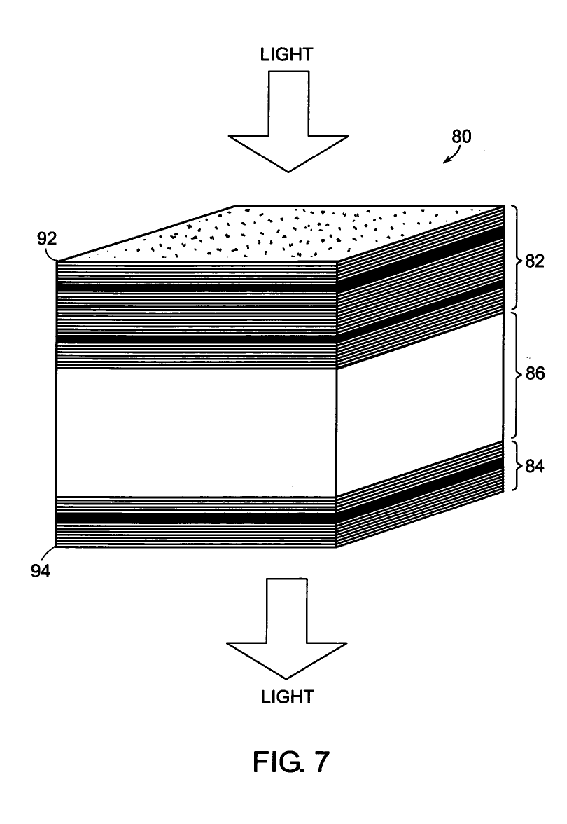

Referring to FIG. 7, an optical switch 80 that illustrates an embodiment from the second category mentioned above is an integral structure including two thermo-optic cavity or multi-cavity filter portions 82 and 84 separated by a precisely fabricated thermal isolation layer 86, e.g. a dielectric layer or air gap. The thickness of the spacer is chosen so that the two filter portions form a single multi-cavity structure. Each of tunable optical filter portions 82 and 84 has transmission characteristics comparable to the tunable filters previously described. Each of tunable optical filter portions 82 and 84 also includes corresponding heater films 92 and 94 by which the location of the passband of that filter can be controlled. Since thermal isolation layer 86 thermally isolates one tunable filter from the other, the two optical filters can be tuned independently of each other.

Optical switch 80 will transmit an optical signal when the two passbands are aligned. This produces a “hitless” tunable filter which is transmissive at targeted channel wavelengths but substantially less so during the tuning process. For hitless operation, the filters of the switch are tuned from one channel to another in a two-step sequence of operations. Initially, the temperature of the upper portion, Tᵤ matches that of the lower portion, Tᵤ=Tₗ, so that the whole unit acts as a single coherent design. In the first step of tuning to a new channel, the temperature of the upper portion is changed from that of the lower by means of the upper heater film, Tᵤ>Tₗ, causing the transmission through the switch to be suppressed. In the second step, the temperature of the lower portion is also changed, to realign it with that of the upper portion, Tₗ′=Tᵤ′, so that the two portions are again in synchrony again but at a new channel.

The insulating film gap may be air, or alternatively fused silica, whose thermal conductivity is small and whose thermo-optic index coefficient is dn/dT=9.9×10⁻⁶/° K at 300° K, which is about 1/25 that of amorphous silicon and essentially non-tunable. To fabricate such a structure with an air gap, the silicon/silicon nitride structure is desposited on a silicon wafer substrate with the deposition in two parts separated by a silicon dioxide layer which is then patterned by a mask and etch step to provide a partial region of air gap.

Note that the optical filter portions 82 and 84 need not have identical transmission characteristics. In that case, positive temperature control is required to permit transmission of a signal through the switch.

If, at a given moment, the passbands are not aligned, one approach to selecting a new channel is by first adjusting the tunable filter whose passband is closest to the new channel, and then adjusting the other tunable filter such that its passband is aligned with the first tunable filter at the selected transmission channel. In this way, one avoids scanning the passband of one filter through that of the other until the desired wavelength is reached. To interrupt transmission, the control circuitry can adjust the temperature of filter 82 or 84 either up or down such that the filters' passbands are no longer aligned. Since the tunable filters are independently controlled, their temperatures can be controlled simultaneously as well as sequentially.

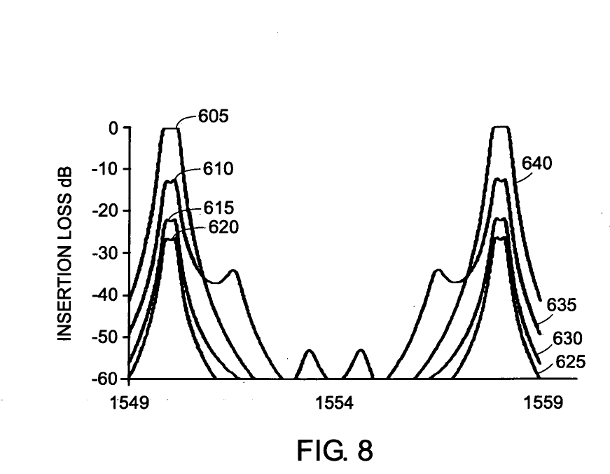

A simulation of a particular design of this type of hitless filter is shown in FIG. 8. The device was designed as a three cavity 100 GHz switch with sixty-five layers using only quarter wave amorphous silicon (H), quarter wave silicon nitride (L), and the insertion of an extra twenty quarter waves of air at a layer determined to be relatively insensitive to optical thickness variations. The resulting structure was as follows:

(0.2814L) (0.3617H) (0.2814L) L (HL)³ 6H L (HL)⁴

(0.4661L) (0.0529H) (0.4661L) L (HL)⁴ 6H L (HL)⁴

(0.4661L)

20 Air

L (0.0529H) (0.4661L) L(HL)⁴ 6H L(HL)³ 0.2814L (0.3617H) 0.2814L.

The notation used here is the same as was used previously. In addition, coefficients are used to indicate a fraction or multiple of quarter wave thickness of the relevant material.

As the simulation for this hitless filter shows, this device is designed for a center wavelength of 1550 nm. At 25° C. (see curve 605), the device has a bandwidth of 55 GHz at −0.5 dB, and a bandwidth of 174 GHz at −25 dB, with a peak insertion loss of −0.3 dB and>23 dB reflection isolation.

To change to channel, initially the lower portion is heated divergently from the upper portion by 90° C. Then, the two portions are matched by heating the upper portion to the higher temperature. The sequence of curves 605, 610, 615, 620, 625, 630, 635, and 640 show the transmission spectrum as a function of time as the heating takes place, with transmission at the lower wavelength (i.e., 1550 nm) first collapsing and then being reconstituted at the higher wavelength (i.e., 1557.7 nm). Note that the transmission is substantially suppressed at wavelengths in between during the tuning process.

Many variants on the above hybrid structures are possible. By adjusting the mirror reflectivities and spacer thicknesses, the temperature range over which switching takes place can be adjusted between 10-100° C. or more. These properties could be used to switch the channel from the drop port to the through port by heating the filter. In addition, any one or more of the optical switches described above can be used to implement an add/drop module in an optical network to control signal transmission in wavelength division multiplexing network architectures, as described next.

Add/Drop Circuit with a Hybrid Structure Filter

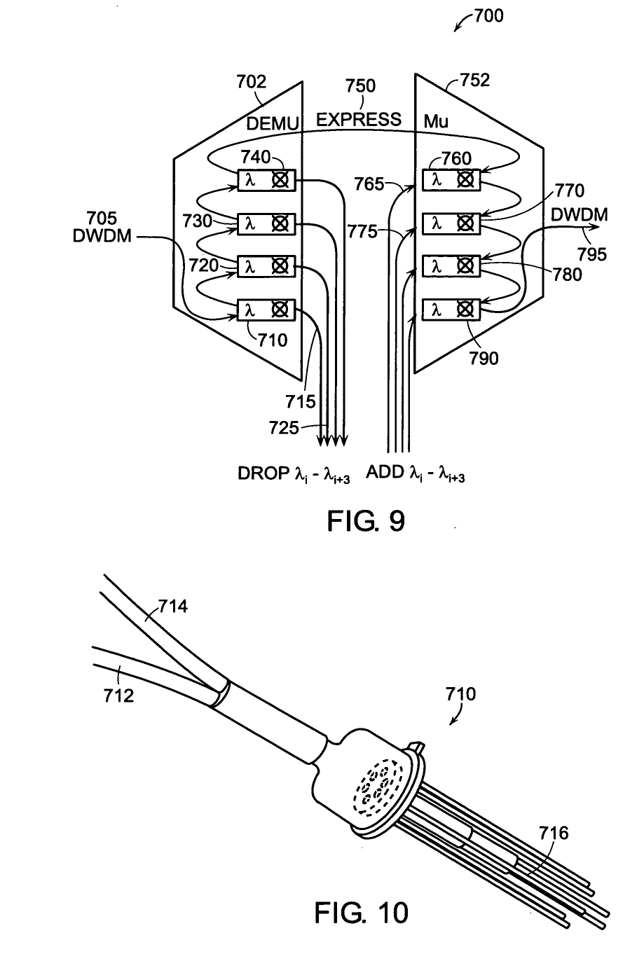

Referring to FIG. 9, an add/drop module 700 that incorporates optical switches of the type described above includes a demultiplexer portion 702 for dropping individual signals at wavelengths λᵢ₊₁, λᵢ₊₂, λᵢ₊₃, and λᵢ₊₄ from an incoming (Dense Wavelength Division Multiplexing) DWDM optical fiber 705 and a multiplexer portion 752 for adding signals at those wavelengths onto an outgoing DWDM optical fiber line 795.

Demultiplexer portion 702 includes four similarly constructed optical switches 710, 720, 730 and 740, each designed for operation at a different one of the corresponding wavelengths λᵢ₊₁, λᵢ₊₂, λᵢ₊₃, and λᵢ₊₄. As illustrated by FIG. 10, optical switch 710 has three optical fibers coupled to it for getting signals into and out of the device. The three optical fibers include in input line 712 for receiving the optical signal, a first output line 714 for receiving a reflected optical signal, and a second output line 716 for receiving the transmitted (or dropped signal). For further details regarding the particular packaging shown in FIG. 10 refer to U.S. Ser. No. 10/306,056 filed Nov. 27, 2002, incorporated herein by reference.

Within demultiplexer module 702 the reflected optical signal from one optical switch is passed to the input of the next optical switch in line. The dropped signals from each optical switch are output on the corresponding output lines (e.g. line 716). The reflected optical signal from the last optical switch 740 is passed to the input of multiplexer module 752.

Multiplexer portion 752 is designed similarly to demultiplexer 702 but it operates in reverse. It includes four similarly constructed optical switches 760, 770, 780 and 790, each designed for operation at a different one of the corresponding wavelengths λᵢ₊₁, λᵢ₊₂, λᵢ₊₃, and λᵢ₊₄. Each optical switch in multiplexer 752 is designed as shown in FIG. 10.

Within multiplexer module 752 the reflected optical signal from one optical switch along with any signal that is added by the optical switch is passed to the input of the next optical switch in line. The reflected optical signal from the last optical switch 790 is the output of multiplexer module 752. The output signal is the input signal to demultiplexer module 702 minus any optical signals that were dropped by the optical switches in demultiplexer 702 plus any optical signals that were added by the optical switches within multiplexer module 752. By appropriately adjusting the on/off states of the optical switches via the heating element(s) within the tunable filters, one can easily select which optical signals are dropped and which optical signals are added by add/drop module 700.

Other embodiments are within the following claims.

What is claimed is:

1. A switchable optical filter comprising:
a first thin-film optical bandpass filter portion; and
a second thin-film optical bandpass filter portion, wherein both the first and second thin-film optical bandpass filter portions are adjacent to each other and are parts of a single integral structure, and wherein the first thin-film optical bandpass filter portion is thermally tunable and is characterized by a passband that shifts as a function of temperature and wherein the second thin-film optical bandpass filter portion is thermally non-tunable.

2. The switchable optical filter of claim 1, wherein the first and second thin-film optical bandpass filter portions are integrally formed one on top of the other.

3. The switchable optical filter of claim 1, wherein the second thin-film optical bandpass filter portion comprises a Fabry-Perot cavity.

4. The switchable optical filter of claim 1, wherein the second thin-film optical bandpass filter portion comprises a plurality of cavities fabricated one on top of the other.

5. The switchable optical filter of claim 1, wherein the second thin-film optical bandpass filter portion comprises an etalon that is characterized by multiple passbands spaced from each other and wherein the passband of first thin-film optical bandpass filter portion is thermally tunable over the multiple passbands of the etalon.

6. The switchable optical filter of claim 1, wherein the first thin-film optical bandpass filter portion comprises a Fabry-Perot cavity.

7. The switchable optical filter of claim 1, wherein the first thin-film optical filter portion comprises a plurality of cavities fabricated one on top of the other.

8. The switchable optical filter of claim 1 wherein the first thin-film optical bandpass filter portion includes a heating element for controlling a temperature of the first thin-film optical bandpass filter.

9. The switchable optical filter of claim 1 wherein the first thin-film optical bandpass filter portion comprises a layer of amorphous silicon.

10. The switchable optical filter of claim 1 wherein the first thin-film optical bandpass filter portion comprises multiple layers of amorphous silicon.

11. A switchable optical filter comprising:
a first thermally tunable thin-film optical bandpass filter portion;
a second thermally tunable thin-film optical bandpass filter portion, wherein both the first and second tunable thin-film optical bandpass filters are arranged next to each other on an optical path; and
a spacer separating and thermally isolating the first and second tunable thin-film optical bandpass filter portions from each other so that either one of said first and second optical bandpass filter portions can be thermally tuned independently of the other one of them.

12. The switchable optical filter of claim 11 wherein the spacer is an air gap.

13. The switchable optical filter of claim 11 wherein the spacer is a solid dielectric material.

14. The switchable optical filter of claim 13 wherein the spacer is made of silica.

15. The switchable optical filter of claim 11 wherein the first thermally tunable thin-film optical bandpass filter portion is characterized by a first passband that shifts as a function of temperature, said first thermally tunable thin-film optical filter portion including a first heater element for controlling a temperature of the first thermally tunable thin-film bandpass filter portion so as to control a location of the first passband.

16. The switchable optical filter of claim 15 wherein the second thermally tunable thin-film optical bandpass filter portion is characterized by a second passband that shifts as a function of temperature, said second thermally tunable thin-film optical filter portion including a second heater element for controlling a temperature of the second thermally tunable thin-film bandpass filter portion so as to control a location of the second passband.

17. The switchable optical filter of claim 15, wherein the first thermally tunable thin-film optical bandpass filter portion comprises a Fabry-Perot cavity.

18. The switchable optical filter of claim 15, wherein the first thermally tunable thin-film optical bandpass filter portion comprises a plurality of cavities fabricated one on top of the other.

19. The switchable optical filter of claim 16, wherein the second thermally tunable thin-film optical bandpass filter portion comprises a Fabry-Perot cavity.

20. The switchable optical filter of claim 16, wherein the second thermally tunable thin-film optical bandpass filter portion comprises a plurality of cavities fabricated one on top of the other.

21. A switchable optical filter comprising:
a first optical bandpass filter portion; and
a second optical bandpass filter portion, wherein both the first and second optical bandpass filter portions are arranged adjacent to each other to form a single interferometrically-coupled optical filter structure, and wherein the first optical bandpass filter portion is tunable and is characterized by a passband that shifts as a function of a control parameter and wherein the second optical bandpass filter portion is non-tunable.

22. The switchable optical filter of claim 21, wherein the control parameter is temperature.

23. A switchable optical filter comprising:
a first tunable optical bandpass filter portioin characterized by a first passband that shifts as a function of a first control parameter; and
a second tunable optical bandpass filter portion characterized by a second passband that shifts as a function of a second control parameter, wherein both the first and second optical bandpass filter portions form a single integral interferometrically-coupled structure.

24. The switchable optical filter of claim 23, wherein the first control parameter is a temperature of the first tunable optical bandpass filter portion and the second control parameter is a temperature of the second tunable optical bandpass filter portion.

25. The switchable optical filter of claim 24 further comprising a spacer separating and isolating the first and second tunable optical bandpass filter portions from each other so that either one of said first and second optical bandpass filter portions can be tuned independently of the other one of them.

26. The switchable optical filter of claim 25 wherein the first tunable optical bandpass filter portion includes a heater element for controlling the temperature of the first tunable optical bandpass filter.

27. The switchable optical filter of claim 26 wherein the second tunable optical bandpass filter portion includes a heater element for controlling the temperature of the second tunable optical bandpass filter.

28. An add/drop optical circuit comprising a plurality of switchable thin-film optical filters each of which has a first optical terminal for receiving an optical signal, a second optical terminal for outputting an optical signal that is reflected by that switchable thin-film optical filter and a third optical terminal for carrying an optical add/drop signal, wherein the switchable thin-film optical filters of the plurality of switchable thin-film optical filters are connected in series via the first and second optical terminals of the plurality of switchable thin-film optical filters and wherein each of the switchable thin-film optical filters of the plurality of switchable thin-film optical filters comprises a thermally tunable thin-film optical bandpass filter portion having a passband that shifts as a function of temperature.

29. The add/drop optical circuit of claim 28 wherein each switchable thin-film optical filter of said plurality of switchable thin-film optical filters further comprises a second thin-film optical bandpass filter portion, wherein both the first and second thin-film optical bandpass filters form a single integral filter structure, and wherein the second thin-film optical bandpass filter portion is thermally non-tunable.

30. The add/drop optical circuit of claim 28 wherein each switchable thin-film optical filter of said plurality of switchable thin-film optical filters further comprises:
a second thermally tunable thin-film optical bandpass filter portion; and
a spacer separating and thermally isolating the first-mentioned and second tunable thin-film optical bandpass filter portions from each other so that either one of said first and second optical bandpass filter portions can be thermally tuned independently of the other one of them, wherein the first-mentioined and second tunable thin-film optical bandpass filter portions and the spacer form a single integral filter structure.
